(19) United States
(12) Patent Application Publication
(10) Pub. No.: US 2026/0258773 A1
(43) Pub. Date: Sep. 3, 2026

(54) METHOD FOR OPERATING AN INTERNAL COMBUSTION ENGINE, CONTROL DEVICE FOR CARRYING OUT SUCH A METHOD AND INTERNAL COMBUSTION ENGINE COMPRISING SUCH A CONTROL DEVICE

(71) Applicant: Rolls-Royce Solutions GmbH, Friedrichshafen (DE)

(72) Inventor: Armin Schwarzenbach, Langenargen (DE)

(73) Assignee: Rolls-Royce Solutions GmbH, (US)

(21) Appl. No.: 19/650,727

(22) Filed: Apr. 17, 2026

Related U.S. Application Data
(63) Continuation of application No. PCT/DE2024/100891, filed on Oct. 16, 2024.

(30) Foreign Application Priority Data
Oct. 17, 2023 (DE) 10 2023 128 468.1

(51) Int. Cl. F02P 17/04

(52) U.S. Cl. CPC F02P 17/04

(57) ABSTRACT

The invention relates to a method for operating an internal combustion engine. During operation of internal combustion engine, a degree of wear for at least one ignition device assigned to a combustion chamber of the internal combustion engine is determined by determining an ignition time-point limit value for retardation of an ignition time-point of the at least one ignition device. The degree of wear is obtained based on the determined ignition time-point limit value.

### CROSS REFERENCE TO RELATED APPLICATIONS

This is a continuation of International Patent Application No. PCT/DE2024/100891 filed on Dec. 16, 2024, which is incorporated in its entirety herein by reference. International Patent Application No. PCT/DE2024/100891 claims priority to German Patent Application No. 10 2023 128 468.1 filed on Oct. 17, 2023, which is incorporated in its entirety herein by reference.

### BACKGROUND OF THE INVENTION

### 1. Field of the Invention

The invention relates to method for operating an internal combustion engine, a control device for carrying out such a method and an internal combustion engine comprising such a control device.

### 2. Description of the Related Art

Ignition devices intended for external ignition in combustion chambers of internal combustion engines are typically replaced at firmly established intervals. However, there are disadvantages in many situations with this approach: If an ignition device fails prior to the scheduled replacement date, the availability of the internal combustion engine in question is reduced, and additional, unplanned service work is required. Depending on the engine's load profile, ambient conditions, manufacturing accuracy of ignition devices, and potentially other factors, such ignition devices can also have a significantly longer life span—hereinafter also referred to as running time—than the established replacement schedules would suggest. Specific cases are known in which ignition devices provided a running time of twice their nominal life span. Thus, replacing ignition devices prematurely simply because a firmly established time period has expired can be a considerable waste of resources. There is therefore a need for a way to predict early and accurately an appropriate time to replace an ignition device. Methods that have been proposed to date for this are complex and therefore difficult to implement, especially during regular operation of an internal combustion engine. Methods that are based on a predetermined maximum ignition voltage and compare the actual ignition voltage directly or indirectly with said predetermined maximum ignition voltage fail to consider that problems or faults in the ignition system may lead to the inability to apply the predetermined maximum ignition voltage, which may result in premature failure of the ignition device serviced by the ignition system. Moreover, direct measurement of the ignition voltage is difficult.

### SUMMARY OF THE INVENTION

It is therefore an objective of the current invention to create a method for operating an internal combustion engine, a control device to carry out such a method and an internal combustion engine with such a control device, wherein the aforementioned disadvantages are at least reduced, and optionally do not occur.

The objective is met in that the present technical teaching is provided.

In some embodiments provided according to the current invention, a method for operating an internal combustion engine includes determining a degree of wear for at least one ignition device assigned to a combustion chamber of the internal combustion engine during operation of the internal combustion engine by determining an ignition time-point limit value for retardation of an ignition time-point of the at least one ignition device. The degree of wear is obtained based on the determined ignition time-point limit value.

In some embodiments provided according to the current invention, a control device for an internal combustion engine is designed to determine a degree of wear for at least one ignition device assigned to a combustion chamber of the internal combustion engine during operation of the internal combustion engine by determining an ignition time-point limit value for retardation of an ignition time-point of the at least one ignition device. The degree of wear is obtained based on the determined ignition time-point limit value.

In some embodiments provided according to the current invention, an internal combustion engine includes: at least one combustion chamber; at least one ignition device assigned to the at least one combustion chamber; and a control device designed to determine a degree of wear for at least one ignition device assigned to the at least one combustion chamber during operation of the internal combustion engine by determining an ignition time-point limit value for retardation of an ignition time-point of the at least one ignition device. The degree of wear is obtained based on the determined ignition time-point limit value and the internal combustion engine is designed as a stationary operating internal combustion engine.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of one design example of an internal combustion engine with an example of a control device;

FIGS. 2a and 2b illustrate a theoretical basis of a design example of a method for operating the internal combustion engine according to FIG. 1;

FIG. 3 is a schematic representation of the design example of the process for operating the internal combustion engine according to FIG. 1; and

FIG. 4 is a detailed representation of the process according to FIG. 3.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

The objective is met in particular in that a method for operating an internal combustion engine is created, wherein during operation of the internal combustion engine, a degree of wear for at least one ignition device assigned to a combustion chamber of the internal combustion engine is determined by determining an ignition time-point limit value for retardation of an ignition time-point, wherein the degree of wear is obtained based on the determined ignition time-point limit value. The method proposed herein may advantageously allow a simple determination of the degree of wear of the ignition device and thus in particular of a value which in turn allows a prognosis of the remaining or total running time of the ignition device. Thus, replacement of the ignition device can be planned according to need. On the one hand, this avoids replacing the ignition device too late and unplanned downtime of the combustion engine as a result; on the other hand, a premature and thus uneconomical replacement of the ignition device can be avoided. When determining the degree of wear on the basis of the ignition time-point limit value, it is not possible to separate the effects of wear, in particular the spark gap of the ignition device, on the one hand, and problems or faults of the ignition system on the other. However, problems or faults in the ignition system are implicitly considered, especially in differentiation to methods that use a predetermined maximum ignition voltage, so that the degree of wear allows a realistic assessment to be made, particularly with regard to the remaining running time or total running time of the ignition device.

In the context of the present technical teaching, an ignition system is understood in particular as the component or plurality of components via which the ignition device is supplied with the high voltage to be applied for ignition. The ignition system comprises, in particular, a voltage source and at least one electrical cable connecting the voltage source to the ignition device. Depending on the design, the ignition system may comprise additional components.

The method is carried out in particular during regular operation of the internal combustion engine arrangement. Thus, advantageously, no additional or separate diagnostic measures involving downtime are required.

In the context of the present technical teaching, retarding an ignition time-point refers to adjusting the ignition time-point from its current value towards a dead center assigned to the ignition time-point—in particular, top dead center, also known as ignition TDC—of a piston in a combustion chamber of the internal combustion engine that can be displaced within the ignition system. This can be a rotary piston or a reciprocating piston. In some embodiments, the combustion engine is designed as a reciprocating piston engine. Thus, retarding reduces the interval between the ignition time-point and the associated dead center in the usual manner, provided that the ignition time-point is located before the associated dead center. The interval is typically measured in degrees of crankshaft angle (°CA).

Without wishing to be bound to theory, the ignition time-point limit is in particular a measure of an ignition voltage potential of the ignition device, wherein the ignition voltage potential is a measure of wear and consequently for the remaining running time of the ignition device. In the context of the present technical teaching, an ignition voltage potential is understood in particular to be a voltage difference between a current ignition voltage requirement and a maximum ignition voltage requirement. The maximum ignition voltage requirement is in particular an ignition voltage requirement that the ignition system can barely provide, or an ignition voltage requirement that the ignition system can just no longer provide. In the context of the present technical teaching, an ignition voltage requirement is understood to be, in particular, the ignition voltage required for ignition, especially for generating an ignition spark. In particular, at constant torque, that is, constant load of the internal combustion engine, the ignition voltage requirement increases with increasing running time due to an expanding electrode gap, also referred to as the spark gap, of the ignition device which is designed as an electric spark ignition device or incorporates an electric spark ignition device. Moreover, according to Paschen's law, the ignition voltage requirement also increases with increasing pressure in the combustion chamber assigned to the ignition device, wherein the combustion chamber pressure in turn increases during the compression stroke towards the dead center assigned to the ignition point. This results in a correlation between the current ignition time-point and the current ignition voltage requirement, correspondingly between the ignition time-point limit and the ignition voltage potential, and between the ignition voltage potential and the degree of wear and thus in particular the remaining running time of the ignition device. The degree of wear can thus be advantageously determined from the ignition time-point limit value.

A further development of the invention provides that a degree of wear is determined by a value selected from a predicted remaining running time of the ignition device, a predicted total running time of the ignition device, and a combination of these values. This may advantageously allow for a direct prediction of when the ignition device needs to be replaced or provides a prediction of the total running time and thus the lifespan of the ignition device, wherein the remaining running time and thus the predicted time for replacing the ignition device can be determined by referring to the running time already elapsed.

In some embodiments, the ignition device is designed as an electric ignition device, in particular an electric spark plug, in particular an electric spark ignition device, in particular an electric spark-spark plug, or has an electric ignition device, in particular an electric spark plug, in particular an electric spark ignition device, in particular an electric spark-spark plug.

A further development of the invention provides that the ignition time-point limit value is determined by successively retarding the ignition time-point of the ignition device, starting from a current ignition time-point, that is, a time-point which is intended for the current load point, until at least one misfire criterion for combustion failure in the combustion chamber assigned to the ignition device is detected or a predetermined maximum ignition time-point adjustment is achieved. The combustion failure indicates that the ignition voltage required by the ignition device at the current ignition point, in other words under the current combustion chamber pressure conditions, can no longer be supplied by the ignition system. Since, as already explained, the ignition voltage requirement increases in accordance with Paschen's law with increasing combustion chamber pressure and thus in the direction of the associated dead center, the ignition time-point limit value determined in this way and defined in particular as an ignition time-point difference between the current ignition time-point and an ignition time-point defined by the at least one misfire criterion, allows conclusions to be drawn about the ignition voltage potential and thus the degree of wear of the ignition device.

In some embodiments, the misfire criterion is selected from a group consisting of: dropping below a predetermined exhaust gas temperature limit, dropping below a predetermined combustion chamber power limit for the combustion chamber comprising the ignition device, a drop in combustion chamber pressure, measured in particular by a sensor, (in particular including corresponding changes in a pressure curve analysis), exceeding a crankshaft rotational irregularity limit, a predetermined signal from a calorific value regulator, and a combination of at least two of the aforementioned criteria. If ignition and therefore combustion do not occur in the combustion chamber, a drop in exhaust gas temperature and power output results. Furthermore, from the perspective of the calorific value regulator, the behavior of the internal combustion engine in this case is equivalent to a drop in the calorific value of the fuel used.

In some embodiments, the ignition time-point is retarded iteratively with a predetermined increment. After each adjustment step, it is checked whether the misfire criterion is detected. If the misfire criterion is detected, the ignition time-point limit is determined and the degree of wear is calculated. Otherwise, the iteration continues until the predetermined maximum ignition time-point adjustment is reached.

The predetermined maximum ignition time-point adjustment can be defined as the maximum difference to the ignition time-point currently provided at the present load point; alternatively, the predetermined maximum ignition time-point adjustment can be defined as the latest permissible ignition time-point relative to the assigned dead center.

A further development of the invention provides that the ignition time-point limit is determined as the ignition time-point difference between the current ignition time-point before retardation and the ignition time-point defined by the at least one misfire criterion whereby, in order to obtain a positive sign, the current ignition time-point prior to retardation is optionally subtracted from the ignition time-point defined by the at least one misfire criterion. Due to the ignition voltage requirement increasing towards top dead center according to Paschen's law, the ignition time-point difference is a useful measure of the ignition voltage potential of the ignition device. Especially, in conjunction with knowledge regarding the development of the ignition voltage potential, either from theoretical considerations, test bench trials, or from the history of the existing ignition device, the degree of wear and especially the remaining running time of the ignition device at the current load point-in other words, at the combustion chamber pressure at the current ignition time-point prior to retardation-can then be easily determined from the remaining ignition voltage potential.

In some embodiments, the latest ignition time-point at which a combustion still occurs is used as the ignition time-point defined by the misfire criterion. Specifically, in this case, retardation of the ignition time-point, or the iteration, continues until the misfire criterion is detected at the last ignition time-point of a sequence of ignition time-points, at which point the penultimate ignition time-point is used as the ignition time-point defined by the misfire criterion.

Alternatively, the ignition time-point defined by the misfire criterion is established as the earliest ignition time-point at which the misfire criterion is first detected. Also, in this case, the retardation of the ignition time-point, or iteration, continues until the misfire criterion is detected at the last ignition time-point in the sequence of ignition time-points, at which point, however, the last ignition point is used as the ignition time-point defined by the misfire criterion.

In some embodiments, the current running time of an ignition device of the at least one ignition device is recorded for the subsequent calculation of a coefficient when the misfire criterion is determined for the ignition device.

A further development of the invention provides that no wear is determined, or that the degree of wear is marked as undetectable, or that the degree of wear is set to a predetermined standard value, or that a predetermined maximum running time is issued when the predetermined maximum ignition time-point adjustment is reached without the misfire criterion being detected. In this case it is not possible to determine actual wear of the ignition device and/or a remaining running time or total running time of the ignition device.

The fact that no degree of wear is determined means that the determination of the degree of wear is aborted without a result. The predetermined default value could be, for example, “zero”, “infinity”, “NAN” (“Not A Number”), “n/a” (“not applicable”), or something similar.

Alternatively, or additionally, if the misfire criterion is determined for the first time for an ignition device of the at least one ignition device at a first specific ignition time-point difference, the degree of wear is calculated by multiplying the first specific ignition time-point difference with a predetermined coefficient.

In some embodiments, the predetermined coefficient is in particular a remaining running time factor which, when multiplied with the ignition time-point difference, results in the predicted remaining running time.

In some embodiments, the predicted remaining running time is initially calculated as an initial degree of wear. It is possible that, in a further step, the predicted total running time is calculated from this as a second degree of wear. Alternatively, the predicted total running time is calculated directly.

In some embodiments, the predetermined coefficient depends on at least one value, selected from a group consisting of an instantaneous power or load of the internal combustion engine, an instantaneous emission of the internal combustion engine, the current ignition time-point prior to retardation, and a combination of at least two of the aforementioned variables. In particular, the predetermined coefficient can be read from a characteristic map, a table, or a file.

Alternatively, the predetermined coefficient is used as the last calculated value from a previous ignition device that was used for the combustion chamber before the currently contemplated ignition device. Another alternative is to use a mean value from historical research of ignition devices from other internal combustion engines as the predetermined coefficient.

In another embodiment, the use of a predetermined coefficients may be omitted entirely. In this case, however, the degree of wear cannot be determined when the misfire criterion is detected for the first time for the ignition device, but only when the misfire criterion is detected at least a second time. Nevertheless, when the misfire criterion is first detected, the current running time of the ignition device is optionally recorded for later calculation of the coefficient.

Alternatively, or additionally, if the misfire criterion is detected for the ignition device at least the second time at a second specified ignition time-point difference, the degree of wear is calculated by multiplying the second specified ignition time-point difference with a calculated coefficient.

In some embodiments, the calculated coefficient is in particular a remaining running time factor which, when multiplied with the ignition time-point difference provides the predicted remaining running time.

In some embodiments, the calculated coefficient is calculated as the quotient of a running time difference between the current running time of the ignition device and its running time at the time of the last detection of the misfire criterion divided by an ignition time-point difference-difference between the ignition time-point difference assigned to the last detection of the misfire criterion and the second determined ignition time-point difference. Without wishing to be bound by theory, the ignition time-point difference can be used as a measure of the ignition voltage potential and the thus calculated coefficient can be regarded as local slope of a type of running time curve of the ignition device, wherein the running time is mapped against the ignition voltage potential or the ignition voltage requirement. Multiplying the coefficient with the current determined ignition time-point difference readily provides the predicted remaining running time at which the ignition system can no longer supply the ignition voltage requirement at the current load point.

In the context of the present technical teaching, running time of the ignition device is understood to mean in particular a period of time, for example a number of operating hours, starting from the first commissioning of the ignition device until the time at which the running time is determined.

An ignition time-point difference-difference is understood to be a difference between two ignition time-point differences.

A further development of the invention provides that prior to successive retardation of the ignition time-point it is verified as to whether the internal combustion engine is at a predetermined load point, wherein successive retardation is only carried out if the internal combustion engine is operating at the predetermined load point. This is based on the idea that, again according to Paschen's law, the ignition voltage requirement depends on the combustion chamber pressure at the current ignition point, wherein the combustion chamber pressure is in turn determined by the load point. Thus, the degree of wear, in particular the predicted remaining running time or total running time, also depends on the combustion chamber pressure and thus on the load point. For example, an ignition device can still be operated readily at lower combustion chamber pressure and lower load due to the lower ignition voltage requirement, whereas the same ignition device may no longer be able to ignite at higher combustion chamber pressure and higher load due to the higher ignition voltage requirement, since the ignition system can no longer supply the corresponding ignition voltage. Therefore, ignition devices typically fail not at low or partial load, but at full load. Accordingly, it makes sense to determine the degree of wear always at the same load point and, in particular, at a high load point, for example at full load or at the highest actual load point, and to check the load point before retardation of the ignition time-point.

In some embodiments, full load is used as the predetermined load point. Full load, in the context of the present technical teaching, is understood to be, in particular, a nominal load point specified especially by the manufacturer of the internal combustion engine. In another embodiment, a highest actual load point within a predetermined, past time frame is used as the predetermined load point; for example, the highest actual load point of the last six months. Thus, it can be considered that internal combustion engines are occasionally operated only below their rated power. As explained above, ignition devices typically fail at high loads, especially at the highest load point, so it can be expedient to use the highest actually reached load point as the predetermined load point.

In some embodiments, it is further checked prior to successive retardation of the ignition time-point whether the internal combustion engine is stationary, running at the predetermined load point, and the successive retardation is only implemented if the internal combustion engine is stationary, running at the predetermined load point. This is based on the idea that determining the degree of wear in a transient operating state hardly makes sense due to the highly variable combustion chamber pressure.

A further development of the invention provides that a degree of wear is determined for a plurality of ignition devices of a plurality of combustion chambers. The procedure described herein can be advantageously expanded to a plurality of combustion chambers and ignition devices.

A further development of the invention provides that the respective degrees of wear for the ignition devices are determined consecutively, with the ignition time-point of the assigned ignition device being successively retarded for only one combustion chamber of the plurality of combustion chambers at a time, while the ignition time-points for the remaining combustion chambers of the plurality of combustion chambers are kept constant. In this way, successive retardation always occurs only for one ignition device and only for one combustion chamber, so that any momentary power loss of the internal combustion engine due to the method is minimal.

In particular, the degrees of wear are determined iteratively via the ignition devices and thus simultaneously iteratively via the combustion chambers, whereby in each iteration, the ignition time-point of the associated ignition device is successively retarded for only one combustion chamber of the plurality of combustion chambers.

A further development of the invention provides that the at least one degree of wear is determined repeatedly, in particular at predetermined time intervals, in particular periodically, or event-driven. The method is thus carried out repeatedly, optionally periodically or event-driven. A chronological development of the at least one ignition device can therefore be advantageously observed and especially reliably predicted.

In some embodiments, the determination of the degree of wear occurs repeatedly after a predetermined number of operating hours of the internal combustion engine, after expiration of a predetermined waiting period or at a predetermined recurring time, for example, always on Sunday night at 7 pm. Alternatively, the degree of wear is determined depending on the occurrence of a certain event.

A further development of the invention provides that the method is carried out on a stationary operating internal combustion engine, in particular a stationary gas engine. Stationary operating internal combustion engines typically operate at the same load point for a great proportion of their operating time, especially at full load or above full load, typically for over 90% of the operating time, which is why performing the method on a stationary operating internal combustion engine can be especially advantageous.

Alternatively, the method can also be carried out on a mobile internal combustion engine, in particular an internal combustion engine used to drive a vehicle, in particular a mobile gas engine. For example, a vehicle powered by a gas engine can deliver its highest torque during acceleration, which corresponds to a maximum load on the ignition system. The method could then be applied for example, specifically during such a maneuver.

In some embodiments, the method is carried out with an internal combustion engine driven by an electric machine which is operated as a generator, wherein this combination of electric machine operating as a generator and internal combustion engine driven by it is also referred to as a generator set or genset. Such internal combustion engines typically operate over a very high proportion of their operating time, typically over 95% of the operating time, at the same load point, especially at full load or above full load.

This applies in particular to internal combustion engines designed as gas engines. In some embodiments, the method is therefore carried out on an internal combustion engine operated as a gas engine, in particular a stationary gas engine, especially on a gas engine in combination with an electric machine which is drive-effectively connected to it and is operated as a generator, in other words, a gas genset.

The objective is also met in that a control device for an internal combustion engine is created which is designed to carry out an inventive method or a method according to one of a number of the previously described embodiments. The advantages already explained in connection with the method are particularly evident in connection with the control device.

The control device is specifically designed for operative connection with the at least one ignition device for control of same, in particular for supplying it with an electrical ignition voltage and/or an electrical discharge current. Alternatively, or additionally, the control device is designed for operative connection with an ignition system assigned to the ignition device for the purpose of supplying it with an electrical ignition voltage and/or an electrical discharge current, for the purpose of controlling the ignition system. In some embodiments, the control device has a correspondingly designed interface for operative connection with the at least one ignition device or with the ignition system.

Ultimately, the objective is also met in that an internal combustion engine is created which has at least one ignition device and one inventive control device or a control device according to one or a number of the previously described embodiments. In connection with the internal combustion engine, the advantages already explained in connection with the method or the control device are particularly evident.

In some embodiments, the at least one ignition device is designed as an electric ignition device, in particular an electric spark plug, in particular an electric spark ignition device, in particular an electric spark-spark plug; or the at least one ignition device has an electric ignition device, in particular an electric spark plug, in particular an electric spark ignition device, in particular an electric spark-spark plug.

The control device is operatively connected, in particular to the at least one ignition device for control of same, especially for supplying the latter with an electrical ignition voltage and/or an electrical discharge current. Alternatively, or in addition, the control device is operatively connected to an ignition system of the internal combustion engine, which is associated with the ignition device for supplying it with an electrical ignition voltage and/or an electrical discharge current, in order to control it.

The internal combustion engine has at least one combustion chamber which has assigned to it at least one ignition device for remote ignition of a combustion in the combustion chamber. In some embodiments, the internal combustion engine has a plurality of combustion chambers, wherein at least one ignition device is assigned to each combustion chamber.

In some embodiments, the internal combustion engine is designed as a reciprocating piston engine. In some embodiments, the internal combustion engine is designed as a gas engine.

In some embodiments, the internal combustion engine is designed as a stationary internal combustion engine, in particular as a stationary gas engine. Alternatively, the internal combustion engine is designed as a mobile internal combustion engine, in particular as a mobile gas engine.

In some embodiments, the in particular stationary-internal combustion engine is drive-effectively connected with an electric machine that is operated as a generator. In some embodiments, the-in particular stationary-internal combustion engine, designed as a gas engine, is drive-effectively connected with an electric machine that is operated as a generator. A mobile internal combustion engine can also be drive-effectively connected with an electric machine operating as a generator.

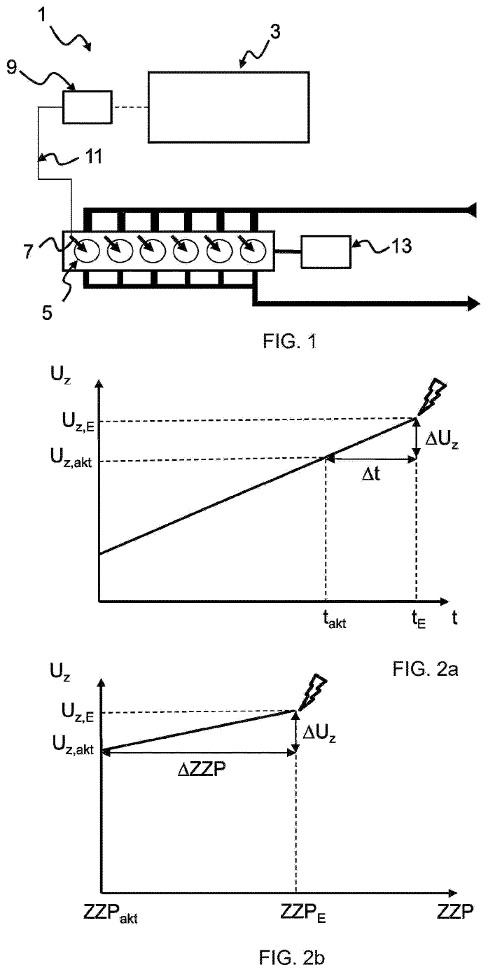

Referring now to the drawings, FIG. 1 is a schematic representation of a design example of an internal combustion engine 1 with a design example of a control device 3.

Internal combustion engine 1 has at least one combustion chamber 5, in this example a plurality of combustion chambers 5, or which only one is indicated with the corresponding reference numeral for sake of clarity, and also assigned to respective combustion chamber 5 for external ignition of combustion in the combustion chamber at least one ignition device 7, which is optionally designed as an electric ignition device, in particular an electric spark plug, in particular an electric spark ignition device, in particular an electric spark-spark plug, or which comprises an electric ignition device, in particular an electric spark plug, in particular an electric spark ignition device, in particular an electric spark-spark plug. Each of combustion chambers 5 has assigned to it at least one ignition device 7, wherein, for the sake of clarity, only one ignition device 7 is marked with corresponding reference symbols.

Control device 3 is operatively connected with ignition device 7 for control of same, in particular to supply it with an electrical ignition voltage and/or an electrical discharge current. In the shown design example, control device 3 is operatively connected to ignition system 9 of internal combustion engine 1, which is associated with ignition devices 7 for the supply of an electrical ignition voltage and/or an electrical discharge current. Ignition system 9 optionally comprises a voltage source which is not shown separately here, and at least one electrical line 11 via which the voltage source is connected to ignition device 7. Ignition system 9 may include further components.

Internal combustion engine 1 is optionally a stationary operating internal combustion engine, in particular a stationary gas engine, optionally a gas engine that is dive-effectively connected with an electric machine 13 that is operated as a generator. However, internal combustion engine 1 can also be designed as a mobile internal combustion engine, in particular as a mobile gas engine, especially also in combination with a generator.

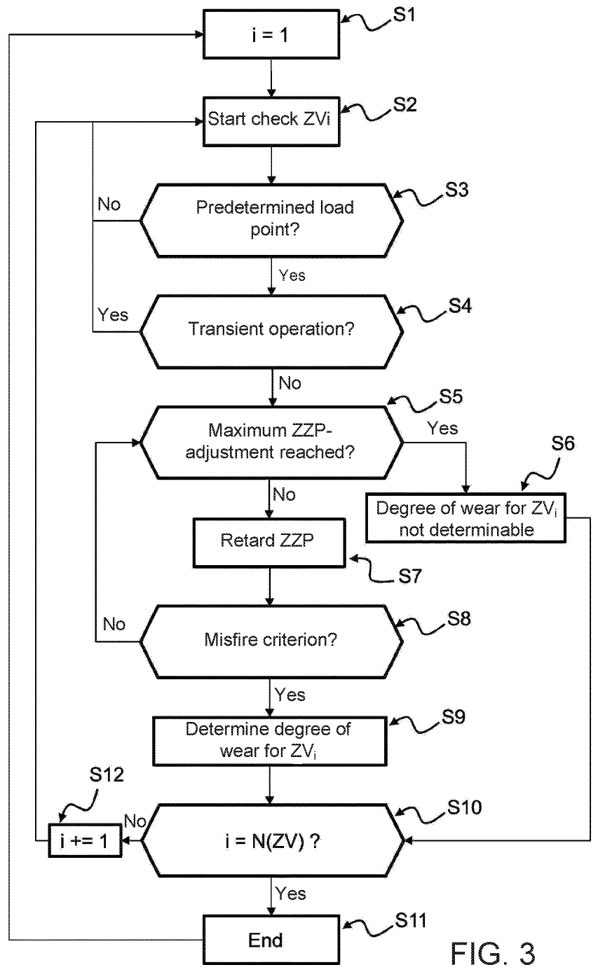

FIGS. 2a and 2b shows the theoretical basis of a design example of a method for operating the internal combustion engine according to FIG. 1.

Identical and functionally equivalent elements are provided with the same reference symbols in all figures, so that reference is made to the preceding description in each case.

In the method for operating internal combustion engine 1, a degree of wear for the at least one ignition device 7 assigned to the at least one combustion chamber 5 is determined in particular during regular operation of internal combustion engine 1 by determining an ignition time-point limit value for retarding of an ignition time-point, wherein the degree of wear is obtained by means of the determined ignition time-point limit value.

The ignition time-point is understood as moving from a current value towards a dead center assigned to the ignition time-point, in particular the top dead center, referred to as ignition TDC, between a compression stroke and an expansion or power stroke of a piston that is movable in combustion chamber 5.

The ignition time-point limit is a measure of the ignition voltage potential of the ignition device, wherein the ignition voltage potential is a measure of the wear and thus also the remaining running time of the ignition device.

This is explained in more detail by means of diagrams in FIG. 2a and FIG. 2b:

In FIG. 2a, the ignition voltage requirement U_{z} of an ignition device 7 at a specific load point at a specific ignition time-point, in other words also at a specific combustion chamber pressure, is plotted against running time t of ignition device 7. Ignition voltage requirement U_{z} is the voltage U that must drop across ignition device 7 at the specified combustion chamber pressure in order for a flashover to occur, in other words, for an ignition spark to be ignited.

Due to wear of ignition device 7, in particular due to erosion of the electrodes, the electrode spacing, namely the spark gap between the electrodes, also known as the striking distance, increases, so that the ignition voltage requirement U_{z} also increases with increasing running time t. Ignition system 9 can only serve a maximum ignition voltage requirement U_{z,E}, or equivalently apply a maximum ignition voltage. Thus, a total running time t_{E} of ignition device 7 is limited by the maximum ignition voltage requirement U_{z,E}. If ignition device 7 has a current ignition voltage requirement U_{z,akt} at a current time, its remaining running time is according to the following equation (1)

Δt:=t_{E}−tₐₖₜ (1)

at the specific load point, that is, at the specific combustion chamber pressure, based on the ignition voltage potential according to the following equation (2)

ΔU_{z}:=U_{z,E}−U_{z,akt}. (2)

If one further assumes that the specific ignition time-point in FIG. 2a is the current ignition time-point ZZPₐₖₜ, then by retarding ignition time-point ZZP from this current ignition time-point ZZPₐₖₜ, a measure of the ignition voltage potential DU_{z} can be determined. This is shown in FIG. 2b.

There, ignition voltage requirement U_{z} is plotted against ignition time-point ZZP at the specified load point. Due to the combustion chamber pressure rising toward ignition TDC, ignition voltage requirement U_{z} also increases with increasing retardation of ignition time-point ZZP. If ignition time-point ZZP is now adjusted from the current ignition time-point ZZPₐₖₜ to an ignition time-point ZZP_{E} defined by at least one misfire criterion—wherein the at least one misfire criterion is characterized by the fact that no spark can be ignited, so that no combustion takes place in combustion chamber 5—an ignition time point difference defined according to the following equation (3)

D ZZP:=ZZP_{E}−ZZP_{act} (3)

is a measure of the ignition voltage potential DU_{z}, since maximum ignition voltage U_{z,E} is reached at ignition time-point ZZP_{E} defined by the misfire criterion.

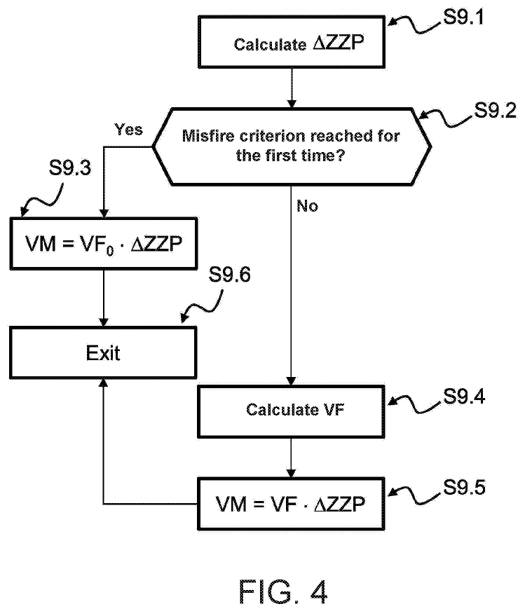

In order to extrapolate the remaining running time Dt or the total running time t_{E} of the ignition devices 7 from the ignition time point difference DZZP, it is necessary to estimate or know the curve, in particular the slope of the ignition voltage requirement U_{z} as a function of the running time t. For this purpose, a suitable assumption can be made, or historical values, values from test bench tests, or previous determinations of the degree of wear can be used, which is explained in more detail in connection with FIG. 4.

FIG. 3 is a schematic representation of the design example of the process for operating internal combustion engine 1 according to FIG. 1.

In the design example shown here, which assumes a plurality of ignition devices 7, wherein each combustion chamber 5 of a plurality of combustion chambers 5 is assigned exactly one ignition device 7, a running variable i for ignition devices 7 is initialized in first step S1—without restricting the generality here-for example with the value one.

In second step S2, a check of ignition devices ZVᵢ assigned to the current value of the running variable i is started.

In third step S3, it is checked whether internal combustion engine 1 is operating at a predetermined load point, in particular at full or rated load, or at the highest actually attained load point actually within a predetermined, past time frame, for example, six months. If this is not the case, the process returns to second step, S2. If, on the other hand, this is the case, the process continues in fourth step, S4.

In fourth step S4, it is checked whether there is transient operation of combustion engine 1. If this is the case, the process returns to second step S2, otherwise the process is continued in fifth step S5.

In fifth step S5, it is checked whether a predetermined maximum ignition time-point adjustment has already been reached. If this is the case, the process continues in sixth step S6, which will be explained later; otherwise, it continues in seventh step, S7. The predetermined maximum ignition time-point adjustment can be defined as the maximum difference to an ignition time-point currently used at the present load point; alternatively, the predetermined maximum ignition time-point adjustment can be defined as the latest permissible ignition time-point relative to the associated top dead center

Starting from a current ignition time-point ZZPₐₖₜ that is allocated to the current load point, ignition time-point ZZP is retarded in seventh step S7, in particular by one ignition time-point increment.

In eighth step, S8, it is checked whether at least one misfire criterion is met. The at least one misfire criterion is optionally selected from a group consisting of falling below a predetermined exhaust gas temperature limit, falling below a predetermined combustion chamber power limit for combustion chamber 5 containing ignition device ZVᵢ, a drop in combustion chamber pressure especially measured by a sensor, (especially including corresponding changes in a pressure profile analysis) in combustion chamber 5, exceeding a crankshaft rotational irregularity limit, a predetermined signal from a calorific value controller, and a combination of at least two of the aforementioned criteria. If the test result is negative, meaning that the at least one misfire criterion is not met, the procedure returns to fifth step, S5.

Otherwise, a degree of wear for tested ignition device ZVᵢ is determined in ninth step S9. This is explained in more detail in connection with FIG. 4. The current running time of ignition device ZVᵢ is optionally recorded for a later calculation of a coefficient when the misfiring criterion for ignition device ZVᵢ is detected. The process is continued in tenth step S10.

However, if it is determined in fifth step S5 that the predetermined maximum ignition time-point adjustment has been reached—without the misfiring criterion having been detected beforehand—it is established in sixth step S6 that the degree of wear for the tested ignition device ZVᵢ cannot be determined. The degree of wear is then optionally marked as undetectable, or the degree of wear is set to a predetermined default value, or a predetermined maximum running time is issued. For example, the default value can be zero, infinite, NAN (Not A Number), n/a (not applicable or not useable), or the like. The process is then continued in tenth step S10.

In tenth step S10, it is checked whether running variable i has reached a final value representing a total number N(ZV) of the ignition devices 7—without restriction of generality with regard to the initialization in first step S1, here the total number N(ZV). If this is the case, the process ends in eleventh step S11.

Otherwise, run variable i is incremented in twelfth step S12, and the procedure is continued in second step S2 with the new value of run variable i for next ignition device ZVᵢ.

In particular, after the end in eleventh step S11, optionally after a predetermined number of operating hours of internal combustion engine 1, the process is started again with first step S1. The degree of wear is therefore optionally determined repeatedly, in particular at predetermined intervals, in particular periodically.

FIG. 4 is a detailed representation of the process according to FIG. 3. In particular, the determination of the degree of wear VM in ninth step S9 is explained with reference to FIG. 4.

In first sub-step S9.1, the ignition time-point difference DZZP between the current ignition time-point ZZPₐₖₜ before the retardation and the ignition time point ZZP_{E} defined by the at least one misfire criterion is calculated according to equation (3).

Ignition time-point ZZP_{E} defined by the misfire criterion is optionally a latest ignition time-point at which combustion still takes place, or an earliest ignition time-point at which the misfire criterion is determined for the first time. In particular, in the first case, according to FIG. 3, the retardation adjustment of the ignition time-point is continued until the misfire criterion is determined at a last ignition time-point in the sequence of ignition time-points, in which case the penultimate ignition time-point is used as ignition time-point ZZP_{E} defined by the misfire criterion; or the retardation adjustment of the ignition time-point is continued in the latter case until the misfire criterion is determined at the last ignition time-point in the sequence of ignition time-points, wherein the last ignition time-point is then used as ignition time-point ZZP_{E} defined by the misfire criterion.

In a second sub-step S9.2, it is checked whether the misfire criterion for the tested ignition device ZVᵢ has been reached for the first time in a series of runs of the procedure according to FIG. 3, from first step S1 to eleventh step S11. If this is the case, the process continues in third sub-step S9.3, otherwise in fourth sub-step S9.4.

In third sub-step S9.3, the degree of wear VM is calculated by multiplying the ignition time-point difference DZZP calculated in first sub-step S9.1 by a predetermined coefficient VF₀ as shown by the following equation (4):

VM=VF₀·DZZP. (4)

Predetermined coefficient VF₀ is optionally dependent on at least one variable selected from a group consisting of: an instantaneous power or load of the internal combustion engine, an instantaneous emission of the internal combustion engine, the current ignition time-point before retardation, and a combination of at least two of the aforementioned variables. In particular, the predetermined coefficient can be read from a characteristic map, a table, or a data set.

Alternatively, the predetermined coefficient VF₀ can be a last value of a calculated coefficient VF of a precursor ignition device 7, which—until its replacement—was used before the currently considered ignition device ZVᵢ for combustion chamber 5 that is assigned to it, or an average value from historical determinations on ignition devices 7 of other internal combustion engines 1.

Ninth step S9 then ends in fifth sub-step S9.6, and the process continues in tenth step S10.

In fourth sub-step S9.4, a calculated coefficient VF is calculated, optionally as the quotient of a running time difference between current running time tₐₖₜ of the ignition device and its previously current running time t′ₐₖₜ at the time of the last determination of the misfire criterion, divided by an ignition time-point-difference difference D(DZZP) between an ignition time-point difference DZZP′ associated with the last detection of the misfire criterion and the ignition time-point difference DZZP as shown by the following equation (5):

VF=(tₐₖₜ−t′ₐₖₜ)/(DZZP′−DZZP). (5)

The thus calculated coefficient VF can be regarded as the local slope of the running time curve of ignition device ZVᵢ according to the diagram in FIG. 2a, using the ignition time-point difference DZZP as a measure of the ignition voltage potential DU_{z}, wherein the ignition voltage potential DU_{z} can also be used as a measure of the ignition voltage requirement U_{z}, assuming an unknown but fundamentally established and therefore constant maximum ignition voltage requirement U_{z,E} by ignition system 9. Coefficient VF multiplied by ignition time-point difference DZZP calculated in first sub-step S9.1 thus results in the predicted remaining running time Dt.

In fifth sub-step S9.5, the degree of wear VM is calculated by multiplying the ignition time-point difference DZZP calculated in first sub-step S9.1 with coefficient VF calculated in fourth sub-step S9.4:

VM=VF·D ZZP. (6)

Then step S9 then ends again in fifth sub-step S9.6 and the process is continued in tenth step S10.

The coefficien—-both, the calculated and the predetermined coefficient—is therefore primarily a residual running time factor which, when multiplied with the ignition time-point difference DZZP provides the predicted residual time Dt.

Optionally, the predicted remaining running time Dt is first calculated as a first degree of wear, wherein in a further step based on this—with the current running time tₐₖₜ—the predicted total running time t_{E} can be calculated as a second degree of wear.

In one design example which is not shown here, the use of predetermined coefficient VF₀ can also be omitted entirely. In this case, however, the degree of wear VM cannot yet be determined when the misfire criterion is first detected for ignition device Zᵢ, but only when the misfire criterion is detected at least a second time.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for operating an internal combustion engine, the method comprising:
determining a degree of wear for at least one ignition device assigned to a combustion chamber of the internal combustion engine during operation of the internal combustion engine by determining an ignition time-point limit value for retardation of an ignition time-point of the at least one ignition device, wherein the degree of wear is obtained based on the determined ignition time-point limit value.

2. The method of claim 1, wherein a variable is determined as the degree of wear which is selected from the group consisting of: a predicted remaining running time of the at least one ignition device, a predicted total running time of the at least one ignition device, and a combination of the aforementioned variables.

3. The method of claim 1, wherein the ignition time-point limit value is determined by successively retarding an ignition time-point of the at least one ignition device until at least one misfire criterion for combustion failure in the combustion chamber assigned to the at least one ignition device is detected or a predetermined maximum ignition time-point adjustment is reached.

4. The method of claim 3, wherein the ignition time-point limit value is determined as an ignition time-point difference between a current ignition time-point before retardation and an ignition time-point defined by the at least one misfire criterion.

5. The method of claim 4, wherein at least one of the following is satisfied:
no degree of wear is determined, the degree of wear is marked as undetectable, the degree of wear is set to a predetermined standard value, or a predetermined maximum running time is issued when the predetermined maximum ignition time-point adjustment has been reached without the at least one misfire criterion having been achieved;
the degree of wear is calculated by multiplying a first specified ignition time-point difference with a predetermined coefficient when the at least one misfire criterion is determined for the first time for an ignition device of the at least one ignition device at the first specified ignition time-point difference; or
the degree of wear is calculated by multiplying a second specified ignition time-point difference with a calculated coefficient when the at least one misfire criterion is detected for the at least one ignition device at least for a second time at a second specified ignition time-point difference.

6. The method of claim 5, wherein the calculated coefficient is calculated as the quotient of a running time difference between a current running time of the at least one ignition device and its running time at a time of a last detection of the at least one misfire criterion divided by an ignition time-point difference-difference between an ignition time-point difference assigned to the last detection of the at least one misfire criterion and the second specified ignition time-point difference.

7. The method of claim 3, wherein it is verified as to whether the internal combustion engine is at a predetermined load point prior to successive retardation of the ignition time-point, wherein successive retardation is performed only if the internal combustion engine is operating at the predetermined load point.

8. The method of claim 1, wherein a degree of wear is determined respectively for a plurality of ignition devices of a plurality of combustion chambers.

9. The method of claim 8, wherein the degrees of wear are determined consecutively, with the ignition time-point of the assigned ignition device being successively retarded for only one combustion chamber of the plurality of combustion chambers at a time, while the ignition time-points for the remaining combustion chambers of the plurality of combustion chambers are kept constant.

10. The method of claim 1, wherein the degree of wear is determined repeatedly.

11. The method of claim 10, wherein the degree of wear is determined at predetermined time intervals, periodically, and/or event-driven.

12. The method of claim 1, wherein the method is carried out on a stationary operating internal combustion engine.

13. The method of claim 12, wherein the stationary operating internal combustion engine is a stationary gas engine.

14. A control device for an internal combustion engine, the control device being designed to determine a degree of wear for at least one ignition device assigned to a combustion chamber of the internal combustion engine during operation of the internal combustion engine by determining an ignition time-point limit value for retardation of an ignition time-point of the at least one ignition device, wherein the degree of wear is obtained based on the determined ignition time-point limit value.

15. An internal combustion engine, comprising:
at least one combustion chamber;
at least one ignition device assigned to the at least one combustion chamber; and
a control device designed to determine a degree of wear for the at least one ignition device assigned to the at least one combustion chamber during operation of the internal combustion engine by determining an ignition time-point limit value for retardation of an ignition time-point of the at least one ignition device, wherein the degree of wear is obtained based on the determined ignition time-point limit value, wherein the internal combustion engine is designed as a stationary operating internal combustion engine.

16. The internal combustion engine of claim 15, wherein the internal combustion engine is designed as a stationary gas engine.
